(19) United States
(12) Patent Application Publication
(10) Pub. No.: US 2007/0127994 A1
(43) Pub. Date: Jun. 7, 2007

(54) MAGNETIZED DRILL BIT EXTENSION

(76) Inventor: ROBERT E. WELKER, Arnold, MO (US)

Correspondence Address: CHARLES C. MCCLOSKEY, 763 S. NEW BALLAS ROAD STE. 170, ST. LOUIS, MO, 63141, US

(21) Appl. No.: 11/567,611

(22) Filed: Dec. 19, 2006

Related U.S. Application Data
(60) Provisional application No. 60/748,357, filed on Dec. 7, 2005.

(51) Int. Cl. B23B 51/00

(52) U.S. Cl. 408/226

(57) ABSTRACT

The magnetized drill bit extension provides a socket that accepts bits of various diameters and indicates its location when concealed, as within a wall. The invention has a socket at the end of a drill bit extension with a strong magnet integrated into the socket. The socket accepts round, square, and square corner rounded shanks of bits. The magnet within the socket endures drilling through wood. The socket emanates a magnetic field from within a concealed location that deflects a compass, thus revealing the location of the extension within a wall. Alternatively, a magnet is joined to the spade of a drill bit to reveal its location when concealed.

### CROSS REFERENCE TO RELATED APPLICATION

This non-provisional application claims priority to the provisional application Ser. No. 60/748,357 filed on Dec. 7, 2005 and to the non-provisional application Ser. No. 10/880,399 filed on Jun. 29, 2004 (now U.S. Pat. No. 7,093,822) and all are commonly owned by the same inventor.

### BACKGROUND OF THE INVENTION

The present invention relates to locating an object within a wall, such as when routing electrical wires through walls. The magnetized drill bit extension has particular utility indicating the location of a hole in a cap plate not visible through a wall.

Before pulling wire in walls, the present invention, in cooperation with a bit, prepares a hole and indicates the location of the hole within a wall. Wire can then be pulled through the hole using a magnetic wire pulling system. Magnetic wire pulling systems assist electricians in routing conduits or wires through intersections of walls and floors, and difficult to reach places in structures. In structures, electrical wiring looks unsightly and architects and electricians labor to hide the wiring. In new construction, electricians run wire through floors, walls, and ceilings before the finished surface is installed. In existing structures, electricians run wires inside finished wall, floor, and ceiling spaces. In other buildings, electricians have to fish wire between two desired locations. Fishing wire includes running a tape or a string first between desired locations. Then an electrician ties a pulling cord to the string and advances the pulling cord to the second location. Third, the electrician ties wire or conduit to the pulling cord and advances the wire to the second location for installation in a fixture.

When fishing wire, electricians encounter obstacles within structures that impede wire from advancing to a second location. Sill plates at wall and floor intersections, headers at wall and ceiling intersections, and rafters in attics, among others, impede fishing of wire. Commonly, electricians use a steel band, known as fish tape, to overcome an obstacle during fishing. An obstacle usually takes many attempts before the electrician successfully advances the fish tape beyond the obstacle. An electrician inserts the fish tape at a known point and extends the tape beyond the obstacle to reach a second point. At the second point, an electrician, if skilled, may hit it precisely or more likely, an electrician has to capture the fish tape with a second piece of fish tape. With fish tape being steel, magnets can capture fish tape at the second point.

### DESCRIPTION OF THE PRIOR ART

The use of a magnets to assist electricians in wire pulling is known in the prior art. For example, the patent to Flowers, U.S. Pat. No. 4,527,775, shows a fish tape device that has a roller on the end which is guided by a magnet outside of the wall. This patent specifically refers to feeding conduit but not Romex cable or other types of electrical wiring. This patent does not have a magnetized head within the roller.

The patent to Hale, U.S. Pat. No. 4,572,561, shows a device for locating a wire with an iron slug upon the end. This patent has a liquid filled container that has a magnet within, which responds as it approaches the slug on the wire placed within a wall. And, the patent to James, U.S. Pat. No. 5,522,630, shows an electromagnet lowered into and through a wall, where fish tape secures to the electromagnet. The present invention does not use electrically induced magnetism.

Wire pulling devices, such as fish tape or rod, have seen use in construction and renovation across the country. The fish tape passes through holes in cap plates and sill plates and then guides wire through a wall or around an obstacle. The fish tape though requires holes drilled through the cap plates and sill plates for passage of the fish tape. Once a hole is drilled in a cap plate, the hole can be identified at the drilling location but not beneath the hole in the adjacent lower story of a structure.

The present invention overcomes the difficulty of finding a hole drilled above a story of a structure and concealed within the upper corner of a wall. The present invention also allows a common compass to find it when concealed.

While the above-described devices fulfill their respective, particular objectives and requirements, the aforementioned patents do not describe a magnetized drill bit extension that has a magnetized socket, or a magnet within a socket, that identifies its concealed location to a compass outside a wall.

Therefore, a need exists for a new and improved magnetized extension that accepts a drill bit and that can be used for locating a hole concealed behind a wall in a structure. The present invention substantially fulfills this need. Further, the magnetized drill bit extension substantially departs from the conventional concepts and designs of the prior art. In doing so, the present invention provides a device primarily developed for the purpose of using a magnetized drill bit extension to carry a drill bit into a wall that is then located by a compass to identify concealed hole locations in a structure, typically at the upper corner of a wall.

### SUMMARY OF THE INVENTION

In view of the foregoing disadvantages inherent in the known types of wire locators in the prior art, the present invention provides an improved magnetized drill bit extension, and overcomes the disadvantages and drawbacks of the prior art. As such, the general purpose of the present invention is to provide a new and improved magnetized drill bit extension which has all the advantages of the prior art mentioned heretofore and many novel features that result in a magnetic drill bit which is not anticipated, rendered obvious, suggested, or even implied by the prior art, either alone or in any combination thereof.

To attain this, the present invention essentially comprises a drill bit extension that is magnetized preferably with a strong magnet incorporated into the socket of the extension and using a compass to identify the extension thus indicating its location when concealed prior to pulling wire through a house or other structure. The magnetized extension indicates its position regardless of the size of bit therein. The magnet is integrated into the socket of the extension so that the magnet survives ordinary handling and drilling through wooden structures. The extension emanates a magnetic field from within a concealed location that deflects a compass, thus revealing the location of the bit.

There has thus been outlined, rather broadly, the more important features of the invention in order that the detailed description thereof that follows may be better understood and in order that the present contribution to the art may be better appreciated.

The magnetized extension may also include a socket that is magnetized, a circumferential tapering of the magnet for integrating into the socket, and chemical welding of a magnet into the socket among other ways of joining the magnet to the socket.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved magnetized drill bit extension that has all of the advantages of the prior art and none of the disadvantages.

It is another object of the present invention to provide a magnetized drill bit extension that may be readily and efficiently manufactured and marketed.

It is still another object of the present invention to provide a magnetized drill bit extension that may be readily applied to renovations and repairs in existing structures.

Still another object of the present invention is to provide a magnetized drill bit extension that passes through less than a three quarter inch diameter hole while minimizing cosmetic and structural damage.

Lastly, it is an object of the present invention to provide a magnetized drill bit extension that indicates the location of a drill bit when concealed within a structure.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. In referring to the drawings,

FIG. 1 is an elevation view of the structure of a house in which operates the preferred embodiment of the magnetized drill bit extension of the present invention;

FIG. 2 is a detailed view of a wall and cap plate through which the present invention drills;

FIG. 3 shows the preferred embodiment of the present invention;

FIG. 4 shows a sectional view of embedding a magnet in the socket, thus assembling the present invention;

FIG. 5 describes an alternate embodiment of the present invention; and,

FIG. 6 describes forms of a magnet used in the alternate embodiment of the present invention.

The same reference numerals refer to the same parts throughout the various figures.

### DESCRIPTION OF THE PREFERRED EMBODIMENT

The present art overcomes the prior art limitations by providing a magnetized drill bit extension for detecting the same within a structure, typically a residential frame house.

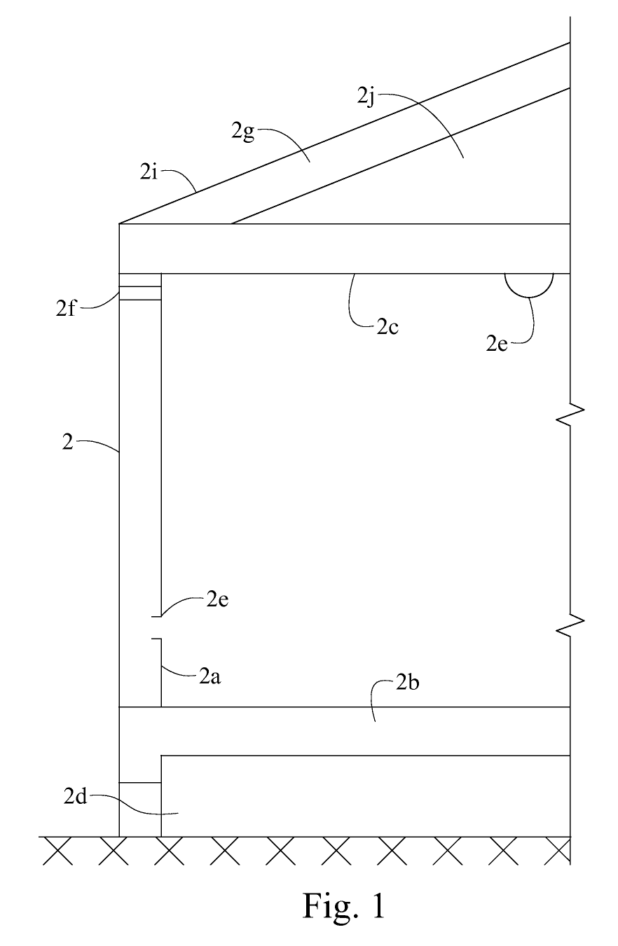

In FIG. 1, the structure of a house is shown wherein the magnetic drill extension 1 operates. Though the preferred embodiment of the present invention is described in reference to a house 2, the present invention can be used in other structures. The present invention overcomes the obstacles inherent with the intersections of walls 2a, floors 2b, and ceilings 2c. Thus, FIG. 1 shows a house 2 with a crawlspace 2d upon the earth. Above the crawlspace 2d, the house 2 has a floor 2b with a wall 2a at the exterior. The wall 2a has an opening for one or more fixtures 2e. The fixtures 2e can be outlets, switches, and the like. The wall 2a has a cap plate 2f upon the top opposite the floor 2b. The cap plate 2f serves as a support for the ceiling joists. The joists 2c are parallel and separated one story in height above the floor 2b. Suspended from the joists 2c, a fixture 2e illuminates the floor 2b. Here, the fixture 2e is a light however other fixtures such as fans are possible. From the joint of the joists 2c with the wall 2a, rafters 2g rise at an angle towards the center of the house 2. The rafters 2g support the roof 2i and an attic 2j exists beneath the roof. Attics 2j are often insulated and rafters 2g have an acute angled connection to the cap plate 2f increasing the difficulty in running wires.

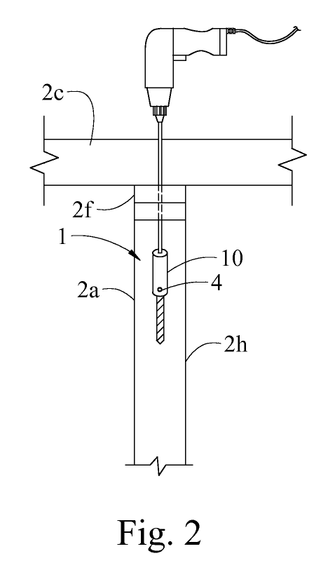

In walls as in FIG. 2, an electrician may want to pull wire up a wall 2a to the joist 2c for further pulling into a ceiling 2c or upper floor 2b. To begin, an electrician attaches the present invention 1 into the chuck of a portable drill. Between two joists, the electrician, in an upper floor, places the present invention 1 upon a cap plate 2f along a line with the desired fixture 2e location. The electrician then drills and advances the present invention into and through the cap plate 2f. When through the cap plate, the electrician stops the drill with the present invention 1 still through the new hole.

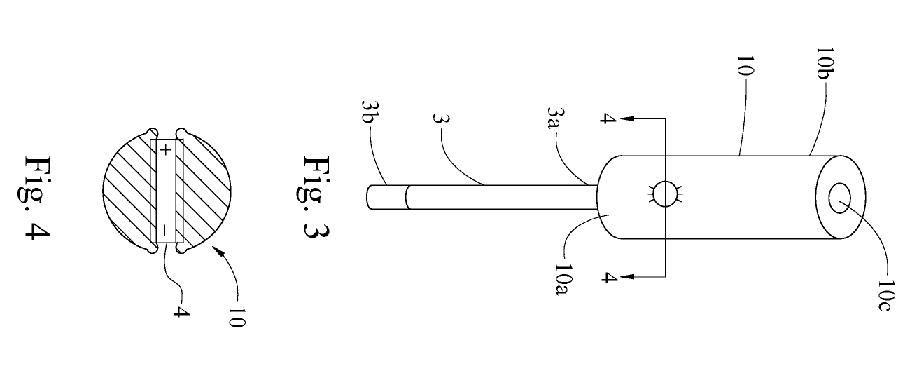

The present invention 1 has a magnet 4 within the socket 2 of the extension later shown in FIGS. 3 and 4. The magnet 4 emanates a field of sufficient strength to penetrate sheetrock and at least one foot beyond the wall. With the drill stopped, the electrician proceeds to a location near the wall. The electrician then opens a magnetic compass and holds the compass horizontal. The electrician notes the orientation of the needle in the compass. Then the electrician moves the compass along the wall a foot or so beneath the ceiling. As the compass nears the present invention 1, the needle will rotate noticeably. Where the needle deflects the most, there the present invention 1 is located behind the sheetrock. The electrician marks that spot as a reference point for fish tape or a magnetic wire pulling system.

Turning to FIG. 3, the present invention 1 comprises a drill bit extension modified to contain a magnet 4. The extension has a shank 3, generally cylindrical and slender with two opposite ends 3a, 3b. The first end 3a has a socket 2 for receiving a drill bit and the second end 3b has a shaft for connecting to a chuck of a drill. The socket 2 has a generally cylindrical shape and a first end 2a joined to the shank 3 and second opposite end 2b that accepts a drill bit. The second end 2b has an aperture 2c in the center parallel to the shank 3 and extending into the socket 2. Generally centered on the socket 2, the present invention 1 has a magnet 4 here shown on end. A round socket is shown though other shapes are possible for the socket.

The magnet 4 is generally cylindrical and extends through the socket upon a diameter and generally below the bottom of the aperture 2c that receives bits. The magnet joins to the socket through a hole 4a of slightly less diameter than the magnet 4 to insure a tight joint. Further, the magnet may be staked to the socket as shown in FIG. 4. Staking deforms the edges of the hole, generally by a punching action, upon the ends of the magnet to secure the magnet upon the socket. The joint of the magnet 4 and the socket endures the rotation of the extension when drilling, the accumulation of wood chips and other detritus, and occasional rough handling. The magnet 4 has sufficient field strength that penetrates at least ½ inch thick sheetrock, or drywall, and at least one foot away from the magnet 4. In the preferred embodiment, the magnet 4 is staked into a hole through the socket and has poles of opposite polarity on the opposite ends of the magnet.

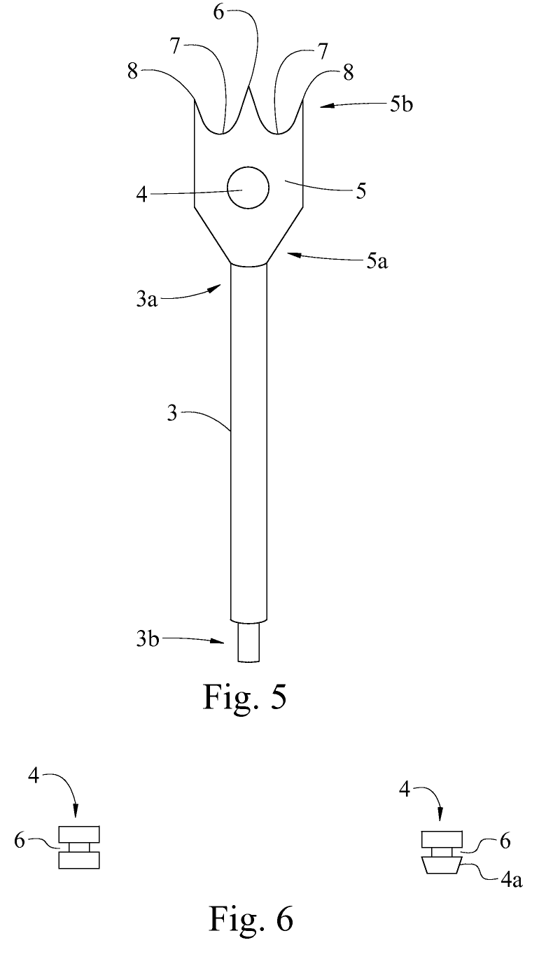

Turning to FIG. 5, an alternate embodiment of the present invention has a spade bit modified to contain a magnet 4. The spade bit has a shank 3, generally cylindrical and slender with two opposite ends 3a, 3b. The first end 3a has a spade 5 for drilling a hole and the second end 3b has a shaft for connecting to a chuck of a drill. The spade 5 has a generally planar shape and a first end 5a joined to the shank 3 and second opposite end 5b for contacting wood. The second end 5b has a tip 6 in the center parallel to the shank 3 and extending outward from the spade 5. The tip 6 has spirals to advance it and then the bit into wood. Flanking the tip 6 are two flutes 7 that have a generally semi-circular shape indented into the bit. Each of the flutes 7 has a sharpened edge with the edges alternating on the top and the bottom faces of the spade 5. The alternating of the edges allows the flutes to excavate a wide hole in wood. The flutes end on the outer edge with outer tips 8. Generally centered on the spade 5 between the tip 6 and the shank 3, the present invention 1 has a magnet 4.

The magnet 4 is generally round and extends slightly above and below the plane of the spade 5. The magnet 4 joins to the spade 5 through a hole. The hole is minutely less in diameter than the magnet 4 to insure a tight joint. The joint of the magnet 4 and the spade resists the rotation of drilling, the accumulation of wood chips, and occasional rough handling. The magnet 4 has sufficient field strength that penetrates at least ½ inch sheetrock and at least one foot away from the magnet 4. In the preferred embodiment, the magnet 4 is pressed, or swaged, into the hole of the spade.

FIG. 6 shows alternate embodiments of the magnet 4 for different joints to the spade 5. In the left of the drawing, the magnet 4 has a circumferential groove 6 generally centered upon the thickness of the magnet 4. The circumferential groove 6 grasps the spade 5 when the magnet 4 is swaged, into a hole of the spade 5. The magnet 4 then overlaps the spade 5 above and below the groove 6. In the right of the drawing, the magnet 4 has a circumferential groove 6 also centered upon the thickness of the magnet 4 and a tapering 4a of one end of the magnet 4. The tapering 4a assists in advancing the magnet 4 into the spade 5 and the groove 6 grasps the spade, retaining the magnet upon the spade during use. The tapering 4a also provides a partial means to indicate which side of the magnet 4 faces an electrician and to show polarity.

An alternate means of joining the magnet 4 to the spade 5 is welding the magnet when in the hole to the spade. A further alternate means of joining the magnet to the spade involves chemically welding the magnet to the spade as with JB Weld® and other compounds that join steel parts via a chemical reaction.

From the aforementioned description, a magnetized drill bit extension has been described. The magnetized drill bit extension is uniquely capable of indicating the location of a drill bit concealed within a wall to a compass outside the wall in a structure. The magnetized drill bit extension and its various components may be manufactured from many materials, including but not limited to steel, nickel, molybdenum, polymers, nylon, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device adapted to secure a drill bit, revealing the location of said device, and having the form of a socket at the end of a slender shank, wherein the improvement comprises:
said socket being magnetized.

2. The location revealing device of claim 1 further comprising:
a magnet having a generally cylindrical shape;
said socket having an aperture opposite said shank and a generally centered hole beneath said aperture, said hole extending radially towards the center of said socket; and,
said magnet being located within said hole.

3. The location revealing device of claim 2 wherein said magnet is staked into said hole of said socket.

4. The location revealing device of claim 2 wherein said magnet is swaged into said hole of said socket.

5. A method of locating a concealed hole, such as within a wall, comprising:
integrating a magnet into a socket of a drill bit extension;
placing said socket with said magnet into a drill;
drilling a hole at a desired location;
leaving said socket with said magnet temporarily in the hole;
bringing a magnetic compass towards the concealed hole;
noting the direction of the compass needle;
moving the magnetic compass in the vicinity of said socket; and,
detecting the location of maximum deflection of the compass needle under the influence of said magnet in said socket.

6. A device that makes a hole and reveals the location of said device, said device having the general form of a spade bit with a planar spade at the end of a slender shank, said spade being greater in width than said shank, wherein the improvement comprises a magnet joined to said spade.

7. The hole making and location revealing device of claim 6 further comprising:
said magnet having a generally cylindrical shape, and a circumferential groove generally centered upon the thickness of said magnet, said groove having an inner diameter;
said spade having a generally centered hole having a diameter slightly larger than the inner diameter of said groove; and,
said magnet being located within said hole of said spade.

8. The hole making and location revealing device of claim 7 wherein said magnet is joined to said spade by one of pressing into said hole, welding into said spade, or chemically bonding to said spade.
